(19) United States
(12) Patent Application Publication
(10) Pub. No.: US 2018/0375258 A1
(43) Pub. Date: Dec. 27, 2018

(54) SELF-ALIGNING CABLE MATING CONNECTOR

(71) Applicant: Dynawave Incorporated, Haverill, MA (US)

(72) Inventor: Anthony R. Scannelli, Haverhill, MA (US)

(21) Appl. No.: 16/014,296

(22) Filed: Jun. 21, 2018

Related U.S. Application Data
(60) Provisional application No. 62/522,841, filed on Jun. 21, 2017.

(51) Int. Cl. H01R 13/631; H01R 24/52; H01R 24/76; H01R 24/68

(52) U.S. Cl. CPC H01R 13/6315; H01R 24/68; H01R 24/76; H01R 24/525

(57) ABSTRACT

A self-aligning connector has a shroud with a beveled or chamfered surface for engaging an adaptor for establishing a coaxial electric connection between cables or appliances. The shroud is part of a backplane connector for receiving rack mounted appliances, and the shrouds are grouped to correspond to connectors of 4, 8 or 16 coaxial connections. Each shroud mates with a corresponding adaptor for closing the coaxial connection. A pin in the center of each shroud engages a receptacle defined by a socket on the mating adaptor. The chamfered surface has a centering taper that guides the socket into alignment with the pin during insertion, and the chamfer centers the socket at an insertion depth greater than the depth for engaging the pin such that the socket is centered before the point of insertion travel where the receptacle engages the pin.

### RELATED APPLICATIONS

This application claims the benefit under 35 U.S.C. § 119(e) of U.S. Provisional Patent Application No. 62/522,841 filed Jun. 21, 2017, entitled “SELF-ALIGNING CABLE MATING CONNECTOR,” incorporated herein by reference in entirety.

### BACKGROUND

Coaxial cables transmit modulated signals over a central conductor surrounded by an insulating core member and shielded by an outer grounding sheath for mitigating outside interference. The entire assembly is wrapped in an insulating material, and connectors crimped, soldered or molded onto the ends for subsequent attachment to a port or device, typically via a threaded, frictional or detent connection. The central conductor achieves certain frequency characteristics based on the thickness of the core through which it passes, and on the continuity of the grounded shielding. Other factors, such as a bend in the cable, can deform the core which changes the thickness and hence, the frequency characteristics. Connectors that join coaxial cables are designed to preserve, or at least limit, any attenuation of signals that occurs.

### SUMMARY

A self-aligning connector has a shroud with a beveled or chamfered surface for engaging an adaptor for establishing a coaxial electric connection between cables or appliances. The shroud is part of a backplane connector for receiving rack mounted appliances, and the shrouds are grouped to correspond to connectors of 4, 8 or 16 coaxial connections. Each shroud mates with a corresponding adaptor for closing the coaxial connection. A pin in the center of each shroud engages a receptacle defined by a socket on the mating adaptor. The chamfered surface has a centering taper that guides the socket into alignment with the pin during insertion, and the chamfer centers the socket at a lesser insertion depth than the depth for engaging the pin, therefore the socket is centered before the point of insertion travel where the receptacle engages the pin. The pin employs a radiused end or point for converging, rather than diverging, with the receptacle. The shroud is also secured in a connector with a protrusion traveling in a groove to allow for aligning movement of the shroud during insertion. Deviations in insertion angle or off-center insertion paths are corrected by the chamfered surface before a misaligned socket can contact the pin and result in possible bent and deformed pins and receptacles.

Configurations herein are based, in part, on the observation that coaxial cables and connections are often preferred for superior transmission of RF (radio frequency) and other high frequency transmissions. The geometry of a central signal-carrying conductor surrounded by a grounding sheath is advantageous for signal transmission. Unfortunately, coaxial connections suffer from the shortcoming that deformation of compromise of the central (concentric) conductor can impede or prevent signal transport. Insertion of cables or connectors at off-center angles can cause the pin and a corresponding receptacle to meet at an angle the causes deformation of the pin and/or socket around the receptacle. Accordingly, configurations herein employ a self-aligning construction that centers the adaptor during insertion such that a centering alignment occurs on the insertion path before the pin enters the receptacle.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIGS. 1A-1C shows the self-aligning connector from the shroud (pin) side as disclosed herein;

FIGS. 2A-2B show a cable side of the connector of FIGS. 1A-1C;

FIGS. 3A-3B show a cutaway view of prior art connectors;

FIGS. 4A-4C show a cutaway view of the self-aligning connector during insertion;

FIGS. 5A-5B show alternate shroud and adaptor configurations of the connector of FIGS. 4A-4C;

FIG. 6 shows a perspective view of backplane having a plurality of self-aligning connectors disposed in arrangements of shrouds; and

FIGS. 7A-7B show the backplane of FIG. 6 disposed in conjunction with rack mounted appliances.

### DETAILED DESCRIPTION

Configurations disclosed below present an example self-aligning connector suitable for use in a backplane connector for rack mounting of multiple communication devices. Alternate configurations may include various shroud and connector arrangements, in addition to the 2*2 and 2*4 connector arrangements discussed, such that each connector is receptive to a coaxial cable.

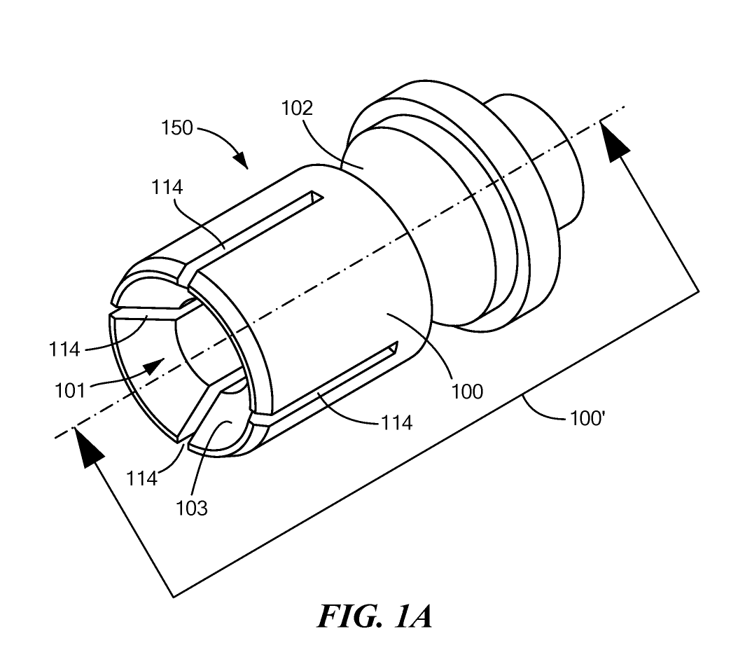

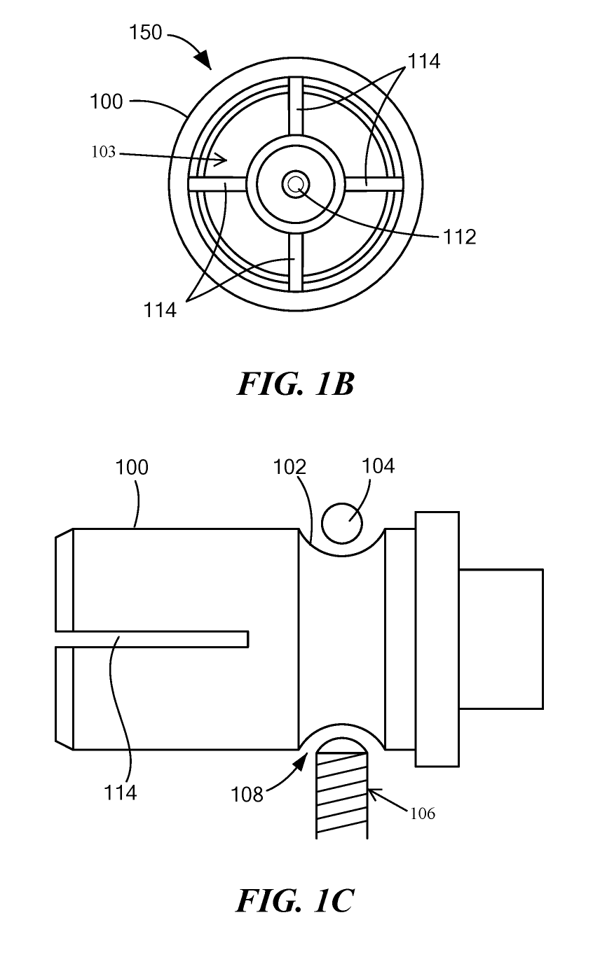

FIGS. 1A-1C show a general form of the self-aligning connector from a shroud (pin) side as disclosed herein. Referring to FIGS. 1A-1C, in a high performance cable transmission environment, a self-aligning connector shroud 150 is adapted for parallel placement with other self-aligning connectors in a mating assembly, including a coaxial connector having an annular body 100 with a bore 101 therethrough. A chamfered or tapered surface 103 lies between an outer circumference of the bore 101 and the circumference of the annular body 100. The connector body 100 has an annular groove 102 for selective engagement with a protruding or elongated perpendicular member 104 for positioning the shroud 150 in the connector assembly.

The annular groove 102 defines a circular depression around the outer circumference of the body 100 adjacent to the chamfered surface 103, such that the annular groove 102 is adapted to engage a threaded member inserted beyond flush with a surface of the body 100 for securing the connector in the housing. The threaded member may engage as a radial screw 106, extending towards the center conductor, or perpendicularly 104. The chamfered surface 103 defines an alignment surface for slideable engagement with an opposed adaptor to engage and center the body 100 as it is drawn nearer the while held position by the threaded member (106, 104) protruding into the groove 102. A tolerance 108 between the threaded member and the annular groove allows for spring biased floating of the shroud 150 while mating with the opposed adaptor.

The connector device as employed herein includes the shroud 150 defined by the annular body 100 and the chamfered edge 103 adapted to receive an adaptor for electrical communication along an insertion axis 100′. The shroud 150 surrounds a male center pin 112 having a radiused end for slideable insertion, in which the pin is centered in the annular body 100. The shroud 150 mates with an adaptor, discussed further below, such that the chamfered edge 103 is disposed to engage the adaptor in a slideable manner for noninterfering engagement of the pin 112 with a socket in the adaptor for electrical communication. The annular body 100 may have slots 114 adapted to allow flexing deformation for frictional engagement with the adaptor. The body 100 spreads slightly at the slots 114 as the adaptor is inserted.

The engaged pin 112 and receptacle are responsive to transport of RF signals. Transmitted signals travel conductively between the pin 112 and receptacle in a manner that maintains signal quality resulting from a length of the pin 112 contacting the receptacle. The body 100 and chamfered surface or edge 103 are typically in electrical communication with a ground for shielding the signal.

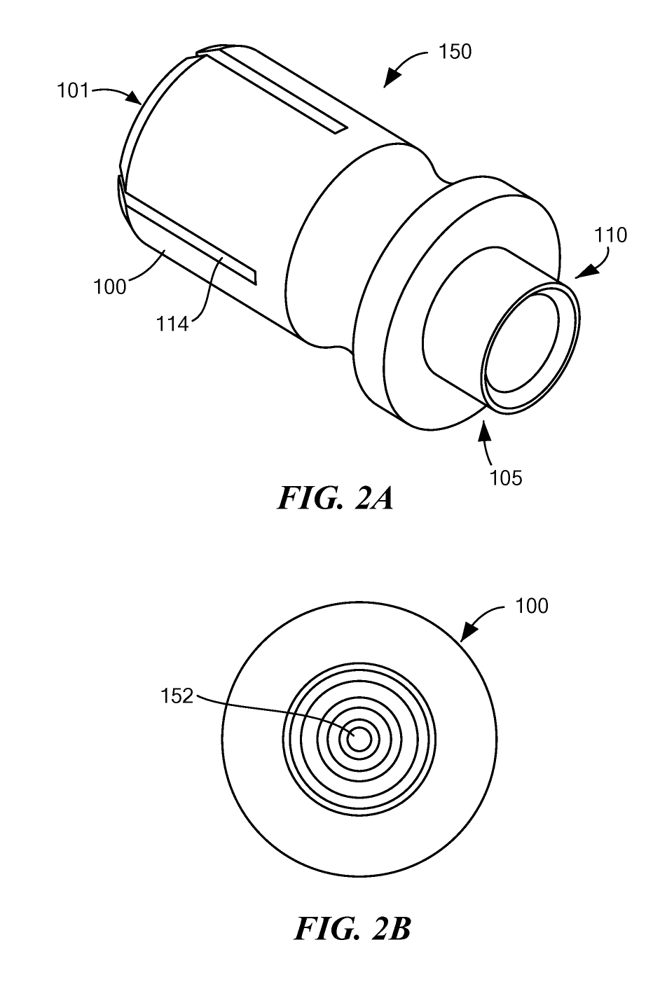

FIGS. 2A-2B show a cable side of the connector of FIGS. 1A-1C. A cable, circuit board or other signal path electrically connects to an opposed side 105 of the shroud 150. A cable receptor 110 secures to a cable by any suitable manner, such as crimping, soldering or molding, and a center conductor 152 conductively attached to the pin 112.

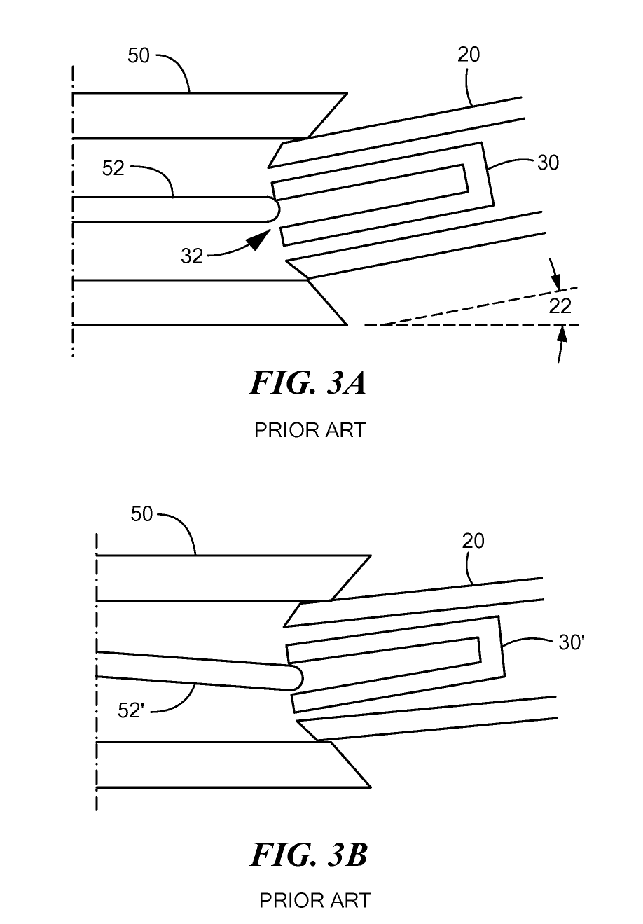

FIGS. 3A-3B show a cutaway view of prior art connectors. Referring to FIGS. 3A and 3B, a conventional adaptor 20 for insertion approaches the conventional shroud 50 along an approach angle 22. Before the shroud 50 contacts and aligns the adaptor 20, a socket 30 defining a conventional receptacle 32 contacts the pin 52. Insertion approaches at angles slightly off parallel may occur when the adaptors are fixed connector arrangements of multiple adaptors, exacerbated by insertion at a rear of a rack mounted appliance. Since the rack mounted appliances are inserted from the front, the mating connectors cannot be seen as the adaptors approach their corresponding shrouds. This is compounded by a tendency to agitate or “wiggle” an inserted appliance in close rack tolerances. The result is bent pins 52′ and bent sockets 30′ as a typical insertion force can deform the pins and sockets due to their small size.

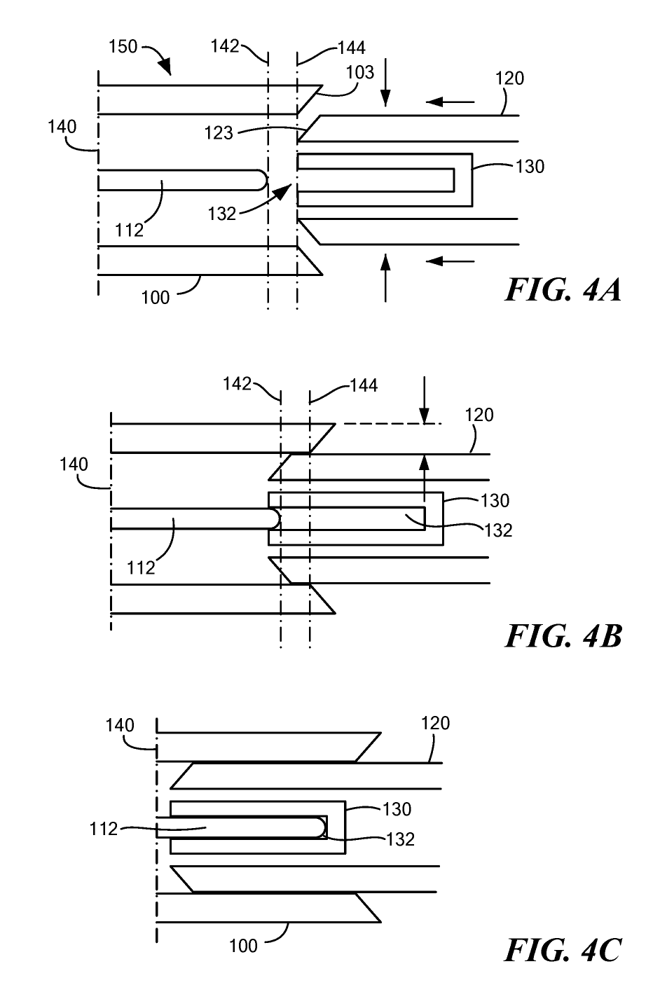

FIGS. 4A-4C show a cutaway view of the self-aligning connector progressing along increasing insertion depth. Referring to FIG. 4A, an adaptor 120 approaches the shroud 150. The chamfered edge 103 is responsive to adaptor 120 insertion for alignment with a receptacle 132 in the socket, as the receptacle 132 is configured for insertion of the pin 112. The chamfered edge 103 is defined by a circumference of the annular body 100 for disposing an approaching socket 130 in radial alignment with the shroud 150 as the adaptor 120 slideably engages the chamfered edge 103. The adaptor 120 and socket 130 define a fixed coaxial connection that electrically connect to a cable or circuit and move as a unit.

The adaptor 120 may have corresponding chamfers 123 for disposing the shroud 150 and adaptor 120 concentrically. The complementary chamfered edge 123 positions the receptacle 132 in the socket 130 in radial and axial alignment with the pin 112 as the adaptor 120 is disposed towards a backplane 140 at a distal end of the shroud 150. The backplane 140 defines a reference plane for insertion, and is the point of maximum insertion where the adaptor 120 “bottoms out” in the shroud 150. Radial alignment means that the radii of the socket 130 and pin are aligned, and axially aligned refers to alignment along the insertion axis 100′ (FIG. 1A).

Continuing to refer to FIGS. 4A and 4B, an alignment plane 144 defines an insertion depth for concentrically aligning the adaptor 120 and the annular body 100, and a contact plane defines an insertion depth at which the pin 112 engages the receptacle 132. As insertion progresses in FIG. 4B, the socket 130 crosses the contact threshold 142 where the pin 112 contacts the inner surface of the receptacle 132 in a sliding engagement. Radial and axial alignment occurs when the alignment plane 144 is crossed before the contact plane upon adaptor 120 insertion into the shroud 150. Therefore, as the adaptor 120 approaches the chamfered edge 103 in FIG. 4A, the chamfered edge 103 is adapted to dispose the socket 130 in radial and axial alignment with the pin 112, such that radial alignment achieved before the axial alignment during insertion, such that axial alignment disposes the pin in a noninterfering engagement with the receptacle. In other words, the chamfered edge 103 draws the inserted adaptor 120 concentrically with the pin 112 before a misaligned angle of approach 22 (FIG. 3A) can cause pin interference.

FIG. 4c shows a fully inserted adaptor 120, where the adaptor “bottoms out” against the backplane 140 and the receptacle 132 fully receives the pin 112, achieving ample and maximum contact area for conduction of the signal. It can be observed that the alignment plane 144 is more distal from the backplane 140 than the contact plane 142, thus ensuring pin 112 alignment before contact.

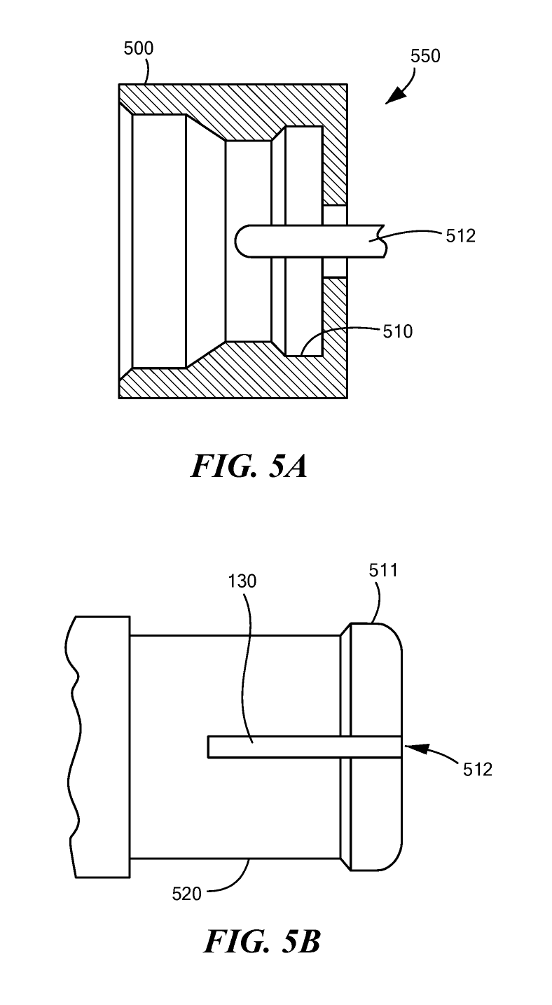

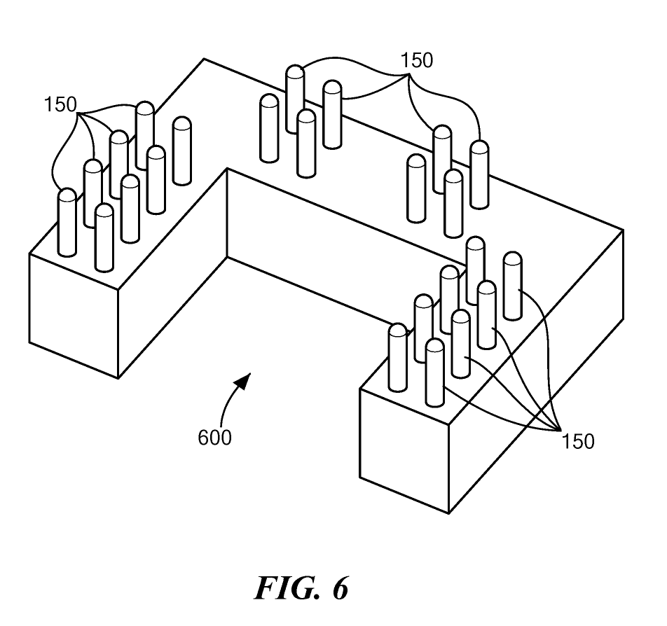

FIGS. 5A-5B show alternate shroud and adaptor configurations of the connector of FIGS. 4A-4C. Referring to FIGS. 4A-4C and 5A-5B, the shroud 150 and adaptor 120 may correspond to an industry standard of connector devices such as SMPM (sub-miniature, push-on, micro). FIGS. 5A and 5B show additional configurations of the claimed approach within the SMPM standard. In contrast to conventional approaches, the alignment threshold and contact thresholds are adjusted to ensure positive alignment along the insertion axis 100 prior to the contact threshold. For example, the length of the pin 512 from the reference plane is between 0.030 and 0.032 in.

In FIGS. 5A and 5B, the shroud 550 and annular body 500 includes a recessed groove 510. The interior of the annular body 500 has the recessed groove 510 for engaging a detent or ridge 511 on the adaptor 520, to provide a positive fixation at full insertion.

FIG. 6 shows a backplane 600 having a plurality of self-aligning connectors disposed in arrangements of shrouds. In an example configuration, the shrouds 150 are arranged in 2*2, 2*4 or other geometries depending on the connectors on the rack mounted devices. Referring to FIGS. 1A, 1C and 6, the body 100 of each shroud 150 includes the circumferential groove 102, such that the circumferential groove is adapted for an interference fit 108 with an elongated member 104, 106 disposed in the circumferential groove. The interference fit defined by a tolerance gap for allowing alignment movement of the shroud 150 in a connector body such as the backplane 600. In particular configurations, in accordance with material deformity and conductivity, the shroud 160 and backplane 600 is constructed of brilliant copper.

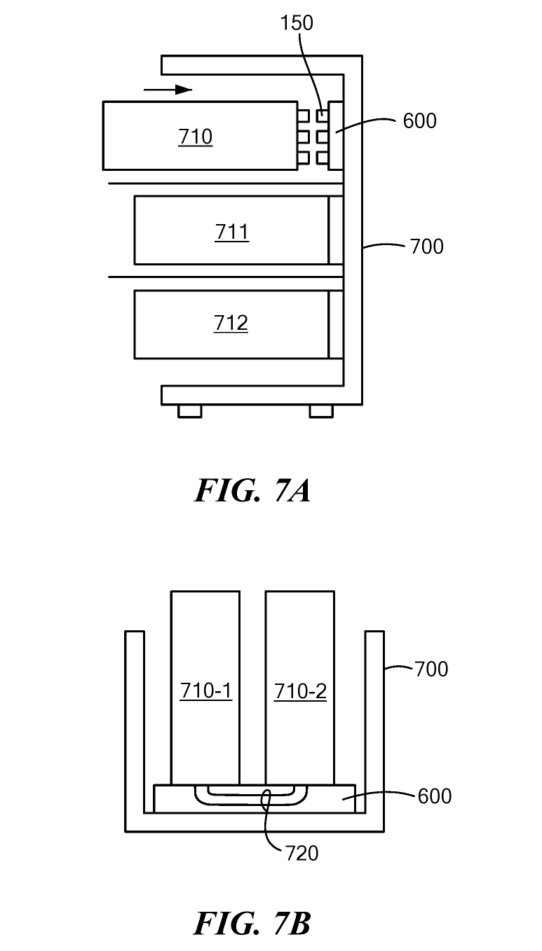

FIGS. 7A-7B show the backplane of FIG. 6 disposed in conjunction with rack mounted appliances 710-712. FIG. 7A is a side elevation, and FIG. 7B shows a plan or top view. The rack 700 includes the backplane connector device, such that the backplane 600 is adapted for attachment to the equipment rack 700. The backplane 600 disposes a plurality of shrouds 150 in a predetermined arrangement for connection to communication devices such as a transmitter 710-1 and a receiver 710-2 inserted into the equipment rack. The backplane 600 forms closed circuits from coaxial cables 720 between the transmitter 710-1 and the receiver 710-2 mounted in the rack.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A cable connector device, comprising:
a shroud defined by an annular body and a chamfered edge adapted to receive an adaptor for electrical communication; and
a pin having a radiused end for slideable insertion, the pin centered in the annular body,
the chamfered edge disposed to engage the adaptor in a slideable manner for noninterfering engagement of the pin with a socket in the adaptor for electrical communication.

2. The device of claim 1 wherein the chamfered edge is defined by a circumference of the annular body for disposing the socket in radial alignment with the shroud as the adaptor slideably engages the chamfered edge.

3. The device of claim 1 wherein the chamfered edge is adapted to dispose the socket in radial and axial alignment with the pin, the radial alignment achieved before the axial alignment during insertion, the axial alignment disposing the pin in a noninterfering engagement with the receptacle.

4. The device of claim 1 wherein the chamfered edge is responsive to adaptor insertion for alignment with a receptacle in the socket, the receptacle configured for insertion of the pin.

5. The device of claim 1 wherein the adaptor has a complementary chamfered edge concentric with the socket, the complementary chamfered edge disposing a receptacle in the socket in radial and axial alignment with the pin as the adaptor is disposed towards a backplane at a distal end of the shroud.

6. The device of claim 5 further comprising an alignment plane and a contact plane, the alignment plane defining an insertion depth for concentrically aligning the adaptor and the annular body, and the contact plane defining an insertion depth at which the pin engages the receptacle, the alignment plane crossed before the contact plane upon adaptor insertion into the shroud.

7. The device of claim 6 wherein the alignment plane is more distal from the backplane than the contact plane.

8. The device of claim 1 wherein the annular body includes a circumferential groove, the circumferential groove adapted for an interference fit with an elongated member disposed in the circumferential groove, the interference fit defined by a tolerance gap for allowing alignment movement of the shroud in a connector body.

9. The device of claim 1 wherein an interior of the annular body has a recessed groove for engaging a detent on the adaptor

10. The device of claim 1 wherein the annular body has slots adapted to allow flexing deformation for frictional engagement with the adaptor.

11. The device of claim 1 wherein the shroud is constructed of brilliant copper.

12. The device of claim 4 wherein the engaged pin and receptacle are responsive to transport of RF signals.

13. A backplane connector device, comprising:
a backplane adapted for attachment to an equipment rack, the backplane disposing a plurality of shrouds in a predetermined arrangement for connection to communication devices inserted into the equipment rack; each of the shrouds further comprising:
an annular body and a chamfered edge adapted to receive an adaptor for electrical communication; and
a pin having a radiused end for slideable insertion, the pin centered in the annular body,
the chamfered edge disposed to engage the adaptor in a slideable manner for noninterfering engagement of the pin with a socket in the adaptor for electrical communication.

14. In a high-performance cable transmission environment, a self-aligning connector adapted for parallel placement with other self-aligning connectors in a mating assembly, comprising:
a coaxial connector having an annular body with a bore therethrough; a chamfered or tapered lip between an outer circumference of the bore and the circumference of the annular body; and
an annular groove for selective engagement with a threaded member for positioning the connector in the mating assembly,
the chamfered lip defining an alignment surface for slideable engagement with an opposed connector.

15. The device of claim 14 wherein the mating assembly further comprises a housing having a plurality of receptacles, each receptacle adapted to receive the connector for positioning a respective connector in other receptacles of the plurality of receptacles.

16. The device of claim 15 wherein the housing includes, for each receptacle, a spring for biasing the connector in a floating position for engaging the opposed connector.

17. The device of claim 15 further comprising an opposed housing for engaging the housing, the opposed housing adapted to engage the respective male or female connector on the housing.

18. The device of claim 15 wherein the receptacles on the housing define a 2*2 or a 4*2 arrangement of cables.

19. The device of claim 15 wherein the annular groove defines a circular depression around the outer circumference of the body adjacent to the chamfered lip, the annular groove adapted to engage a threaded member inserted beyond flush with a surface of the body for securing the connector in the housing.

20. The device of claim 15 further comprising a tolerance between the threaded member and the annular groove, the tolerance allowing for spring biased floating of the connector while mating with the opposed connector.
